(19) United States
(12) Patent Application Publication
(10) Pub. No.: US 2003/0172903 A1
(43) Pub. Date: Sep. 18, 2003

(54) Engine speed control for internal combustion engines

(76) Inventor: Alfonso Perez Carballo, Madrid (ES)

Correspondence Address: NIXON PEABODY, LLP, 8180 GREENSBORO DRIVE, SUITE 800, MCLEAN, VA, 22102, US

(21) Appl. No.: 10/257,387

(22) PCT Filed: Apr. 17, 2001
(86) PCT No.: PCT/AU01/00434

(30) Foreign Application Priority Data
Apr. 18, 2000 (AU) PQ7001

(51) Int. Cl. F02D 1/00

(52) U.S. Cl. 123/333; 123/335; 123/339.11; 123/339.14; 123/350

(57) ABSTRACT

A method of controlling the speed of an engine whilst the engine is operating in a crank or idle state, including the steps of (a) determining when the engine is operating in said crank or idle state; (b) determining whether the engine speed is above an upper threshold speed, and (c) controlling the engine when the engine speed is above the upper threshold speed so as to effect a reduction in the engine speed to avoid an engine speed runaway event.

### FIELD OF INVENTION

This invention relates to a method for disabling an internal combustion engine of a vehicle suffering an engine speed runaway condition. In particular, the invention relates to vehicles comprising speed related engaging devices, for example, continuously variable transmissions and viscous couplings.

### BACKGROUND

The application of continuously variable transmissions to vehicles has become more prevalent over recent years, particularly in regard to scooters, motorcycles, all-terrain vehicles (ATVs) and certain other small vehicle applications. Such vehicles comprising a continuously variable transmission (CVT) are generally relatively simple to operate in that the driver or rider only needs to control throttle or accelerator actuation and not concern themselves with manual shifting between gears as is required in certain alternative arrangements, Broadly speaking, typical CVT arrangements have a threshold engagement speed or speed range at which the engine effectively becomes coupled to the drive-train or wheels of the vehicle. This threshold engagement speed or speed range is typically set above the idle speed of the engine such that throttle actuation from idle will increase engine speed and subsequently cause the CVT to engage resulting in vehicle motion. Accordingly, a CVT may be considered a speed related or speed dependent engagement device.

An alternative type of speed dependent engagement device may be a torque converter of an automatic transmission unit which typically requires engine speed to reach a certain threshold level before the torque converter will enable the engine of a vehicle to be coupled to the drive-train thereof. Among the requirements of such a torque converter are to disengage the engine from the driving wheels, enable re-engagement to the drive-train smoothly and without shock and to allow for variable leverage between the engine and the wheels for variations in applied load, either as a result of environment or operator input.

Other forms of speed dependent engagement devices may for example be defined as such by the presence of viscous couplings or a particular centrifugal clutch arrangement. The common element of such devices is that vehicle motion is only possible once a certain engine speed threshold has been exceeded. As will be discussed further hereinafter, some such speed dependent engagement devices may pose the problem that if the speed of the engine were to exceed the threshold speed at a point in time where vehicle motion was not desired, a driver or rider may be caught unawares and have to act quickly to avoid an accident from ensuing. That is, a certain safety issue may exist which needs to be addressed.

Upon starting of an engine and providing there is no driver demand on the engine, most engines typically go through a crank phase and an idle phase. This is generally true of a majority of vehicle engines and not just those which comprise a speed dependent engagement device. In certain engines, and typically those which are coupled to an automatic transmission comprising a torque converter, engine operation can not begin unless the engine is disengaged from the vehicle drive-train, such as for example when “park” is selected. In other engines, and particularly those comprising a CVT or equivalent type of speed dependent engagement device, no such requirement may be necessary and the fuel and ignition systems of the engine can be operated by an engine control system during a crank mode to effect initial operation of the engine. Furthermore, whilst certain engine applications comprising a CVT may require that the brake be applied before engine cranking can occur, such a relationship between the brake and the ability to crank the engine may not in fact be a function of, or under the control of, the engine control system.

Subsequent to successful commencement of engine operation, the control system then typically provides for a predetermined idle speed to be established and maintained during an idle phase of operation. At this point the engine throttle is typically closed and the engine remains disengaged from the drive-train of the vehicle. As the driver demand increases from idle, the engine will eventually engage the vehicle drive-train through the transmission unit whereafter engine operation will be dependent upon, amongst other things, the load imposed by the operator and road conditions.

During the crank and idle modes of operation, it is normally expected that the engine speed will not exceed a predetermined threshold level. This is particularly so in engines fitted with speed dependent engagement devices where unexpected attainment of a threshold engagement speed may cause the engine to be coupled to the vehicle drive-train resulting in vehicle motion at a time when it is not desired or expected. Still further, and regardless of the transmission unit to which the engine is coupled, it is normally expected that the engine speed will be below some predetermined threshold level during the crank and idle modes of operation.

If however, as a result of some mechanical or system error the fuel delivery means of the engine fuel system remains fully open or the engine fuel system were for some reason to deliver more fuel than is required during such a crank or idle mode, a significantly higher volume of fuel may be delivered to a combustion chamber of the engine possibly resulting in an undesirable increase in engine speed. The engine may thus experience a speed “runaway” condition with the engine speed potentially increasing to a level significantly in excess of the normal engine idle speed. Such a situation is obviously undesirable as a speed “runaway” condition when no load is applied to the engine may result in damage to the engine. Further, should this coincide with a mechanical failure, prematurely coupling the engine with the vehicle drive-train, the vehicle may lurch forward and even “drive” off. Not only would this create a significant safety hazard, but the impact loading to the drive system may also cause significant impact and fatigue damage.

More particularly, and as alluded to hereinbefore, the unexpected attainment of a threshold engagement speed where the engine is coupled to a speed dependent engagement device would result in the engine becoming coupled to the vehicle drive-train resulting in vehicle motion at a point in time during which it would not be expected or desired by the driver or rider. That is, in the case of a scooter comprising a CVT mechanism for example, an unexpected increase in engine speed during the crank or idle modes of operation may result in the CVT becoming engaged to the engine causing subsequent motion of the scooter.

A similar situation may also arise from a control system error where a significantly higher fuelling rate than is actually desired is effected, thus causing an increase in the engine speed. Consequently, the effect may be the same as the aforementioned failure of a fuel delivery means, in that a significantly higher volume of fuel will be delivered to the combustion chamber. Again, if this results in the coupling of the engine to the vehicle drive-train by a speed dependent engagement device or alternatively coincides with a mechanical failure which couples the engine with the vehicle drive-train, such a combination will present a substantial hazard.

In controlling such emergency or undesirable situations, a mechanical failsafe system could be incorporated into the drive-train, adding further weight and expense to the entire vehicle system. For example, such a mechanical emergency system could be focussed on disengaging the engine from the drive-train should an engine speed runaway event be evident. However, in certain applications, such a rapid disengagement may itself cause damage to the engine or vehicle system perhaps comparable to the damage the runaway event itself may cause. Thus, whilst having means to rapidly terminate a runaway event may be a useful safety feature, certain mechanical systems may themselves raise issues of expense and damage, possibly negating the benefits of including the safety system.

### STATEMENT OF INVENTION

It is therefore an object of the invention to minimize the chances of a runaway event occurring, as a result of mechanical or system failure, using a relatively simple and inexpensive means when compared to the prior art.

Hence, in one aspect of the invention there is provided a method of controlling the speed of an engine operating in a crank or idle state, said engine connected to a vehicle drive-train through a speed related engagement device having a predetermined engagement speed or speed range at which the engine becomes coupled to the vehicle drive-train, including the steps of determining when the engine is operating in said crank or idle state; determining whether the engine speed is above an upper threshold speed, and controlling the engine when the engine speed is above the upper threshold speed so as to effect a reduction in the engine speed to avoid an engine speed runaway event.

Conveniently, the engine is disabled by preventing fuel delivery events to the engine when the engine speed is determined to be outside the predetermined speed range.

Preferably, the method of controlling the speed of the engine includes disabling all the scheduled events associated with the generation of a combustion event in at least one combustion chamber of the engine. The scheduled events associated with the generation of combustion typically include a fuel delivery event and an ignition event. In a single fluid fuel system, fuel metering may typically take place during the fuel delivery event itself, whilst in a two fluid fuel system, a specific fuel metering event may be scheduled as a separate event to the fuel delivery event. Accordingly, this separate fuel metering event may be one of the scheduled events, which is disabled so as to avoid an engine runaway condition or event. Other suitable methods may also be employed to control or restrict the engine speed in order to prevent an engine speed runaway condition.

Whilst disengaging the engine from the vehicle drive-train has the potential to cause harm to the engine and the drive-train, if the engine itself can be disabled it will have the same effect as a stall situation and thus have little or no detrimental effect on the vehicle system whilst still preventing a foreshadowed hazard caused by the speed runaway event.

Preferably, said engine is connected to a vehicle drive-train through a speed related engagement device. As mentioned hereinbefore, such speed related engagement devices typically have a predetermined engagement speed or speed range at which the engine becomes coupled to the vehicle drive-train. Conveniently, the predetermined speed range outside of which the engine is disabled is selected such that an upper threshold speed is below the engagement speed of the speed dependent engagement device. In this way, if the engine speed were to unexpectedly increase during the crank or idle state, coupling of the engine to the vehicle drive-train would not occur as the predetermined engagement speed of the speed dependent engagement device would not be attained by the engine. That is, the combustion related events such as fuel metering, fuel delivery and/or ignition would be disabled prior to the predetermined engagement speed being attained, hence causing the engine to cease operation.

Conveniently, an engine management control system arranged to control engine operation may determine the speed of the engine and compare this with the predetermined engagement speed for the device such that the engine can be disabled prior to this engagement speed being attained.

As part of the engine management control system, there is typically encoded ideal ranges within which the engine speed during the crank or idle state would be expected to fall. The control system will thus react to an engine speed falling outside these ranges by disabling the engine. The present invention is targeted at those instances where, through mechanical or system failure, the engine speed is caused to increase such that it exceeds the pre-determined ranges or limits. Accordingly, in this embodiment of the invention, when a maximum upper limit is reached or exceeded, the present invention provides means to disable the engine so as to prevent an engine speed runaway event.

More preferably, the speed related engagement device may be a continuously variable transmission (CVT) or a viscous coupling. Such CVTs typically have a threshold CVT speed or speed range at which the CVT enables coupling of the engine to the vehicle drive-train. Conveniently, the upper threshold speed at which the engine is disabled is set at a level below the threshold CVT speed. Alternatively, the upper threshold speed may be the threshold CVT speed for the device.

Conveniently, having made a comparison of engine speed with the upper threshold speed, the control system may implement a strategy to disable the engine. Comparing the engine speed to the upper threshold speed, said upper threshold speed being set at a level less than is desired for the engagement of the speed related engagement device, ensures that the engine is disabled if the engine speed exceeds the upper threshold speed thus ensuring that no vehicle motion or runaway will ensue.

More preferably, the engine may be disabled by any one of, or a combination of cutting fuel and air events in the case of a fuel injection system, or disabling the ignition system.

Even more preferably, the vehicle for which the present invention is applicable may be a scooter or a motorcycle.

Conveniently, where the upper threshold speed is selected to be below the engagement speed of a speed dependent engagement device, the engine control system may be programmed such that a number of opportunities are provided to control the engine speed prior to effecting cessation of engine operation. For example, the control system may allow the engine speed to equal or exceed the upper threshold speed one or two times, each time endeavouring to control the engine speed down to a level below the threshold speed, prior to disabling the engine to prevent an engine speed runaway event. Conveniently, subsequent to the engine speed becoming equal to or greater than the upper threshold speed, the control system may seek to reduce the engine speed to a more desirable level by reducing the fuelling rate to the engine. If on each occasion following an attempted reduction of the fuelling rate the engine speed subsequently once again equals or exceeds the upper threshold level, the control system than takes measures as alluded to hereinbefore to effect cessation of engine operation. Conveniently, in attempting to reduce the fuelling rate to the engine, the control system may seek to enforce the engine to operate at a predetermined idle speed.

Such a strategy of enforcing the adoption of a preset idle speed may also not be limited to use only after the engine speed has made several excursions above the upper threshold speed. Indeed, rather than effect cessation of engine operation as alluded to previously when the upper threshold speed or threshold CVT speed is equaled or exceeded, in certain engine applications, the control system may preferably endeavour to control the engine speed by various means such that it is reduced down to a predetermined idle speed.

The present invention is particularly applicable to clean-bum engines or engines which operate with a stratified charge at some points of the operating load range. For example, the present invention has applicability to engines which comprise the Applicant's dual fluid fuel injection system. In this fuel injection system, the fuel metering and fuel delivery events are separated into distinct events and a metered quantity of fuel is typically delivered into a combustion chamber of the engine entrained in a quantity of compressed air. Such a system is further discussed in the Applicant's U.S. Pat. No. RE36768 and published PCT Patent Application No. WO99/20895, the contents of which are included herein by way of reference.

In such a dual fluid fuel injection system, and in particular one where fuel is delivered directly into the cylinders of the engine, the fuel spray delivered from the fuel delivery injectors is typically stratified during the crank and idle modes of engine operation. That is, the air/fuel ratio is generally leaner than it would be at other operating points. More particularly, the air/fuel ratio tolerance throughout the modes is much greater than that experienced by comparable engines which operate across the load range with an air/fuel ratio that is stoichiometric or homogeneous. As a result, such engines have a large air/fuel ratio window they can operate within when running in stratified mode, and unlike engines running with a homogeneous air/fuel ratio, are much less likely to rich mis-fire or experience unstable combustion if the air/fuel ratio varies significantly. Hence, if additional fuel over and above that determined by the engine management control system is delivered into the engine combustion chamber(s) of such an engine, then because of the large air/fuel ratio operating window, additional torque output can result from the additional fuel resulting in increasing engine speed. In such engines, torque and hence engine speed are in fact directly proportional to the fuelling rate during such modes of operation.

Hence it can be appreciated that engine speed runaway scenarios may be more of an issue for such stratified charge engines as any unexpected or undesired increase in the fuelling rate will be more likely to result in increased engine speed rather than misfires or a loss of torque. Accordingly, if such an engine is fitted with a speed dependent engagement device such as a CVT, if such an increase in engine speed were sufficient to cause the engine to become coupled to the vehicle drive-train (ie: by exceeding the threshold CVT engagement speed or engaging the torque converter), then vehicle runaway may result if the driver is taken unaware. More generally, even if coupling of the engine to the vehicle drive-train does not occur, an uncontrolled increasing engine speed may result in damage to the engine from over-revving or prolonged operation at or above an engine speed which may cause engine deterioration. This may hence also apply to homogenous type engines controlled by a drive-by-wire system where air-flow to the engine can be controlled independently of driver demand. Hence an unexpected increase in the fuelling rate in such an engine may not necessarily result in misfire or unstable operation as a modified airflow as determined by the ECU may also result in an increase in torque and hence engine speed.

### DESCRIPTION OF PREFERRED EMBODIMENT

It will be convenient to further describe the present invention with respect to the accompanying drawing which illustrates a possible arrangement of the invention. Other arrangements of the invention are possible, and consequently the particularity of the accompanying drawings is not to be understood as superseding the generality of the preceding description of the invention.

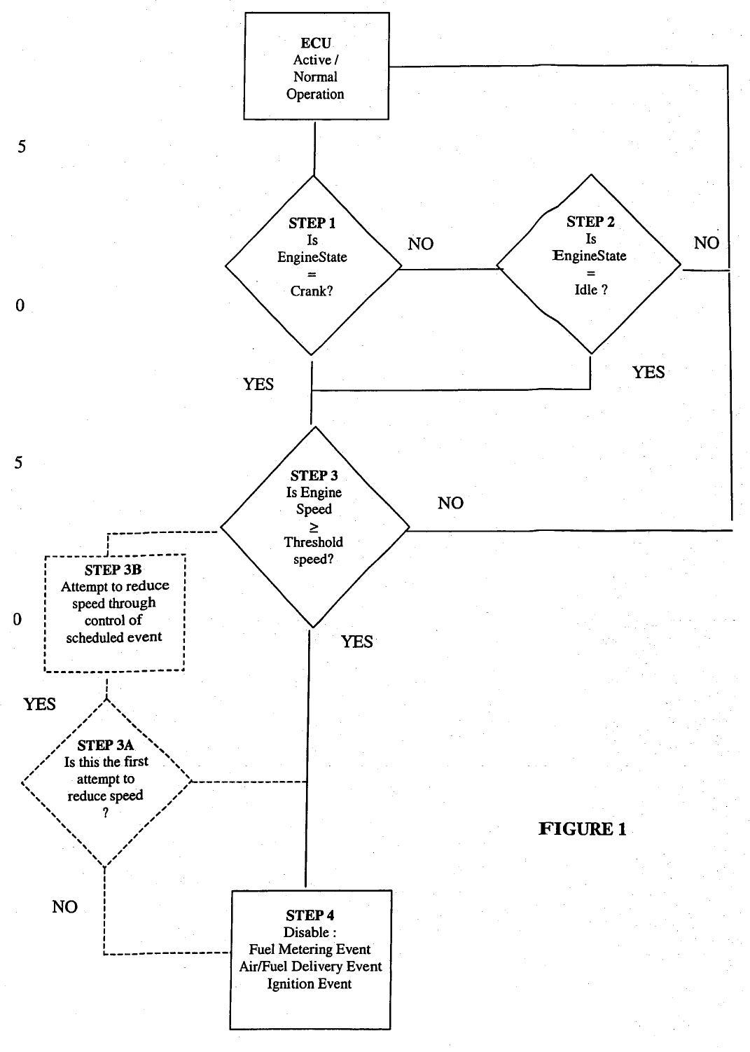

FIG. 1 shows a flow diagram of the control strategy effected by the electronic control unit (ECU) of an engine management system of a vehicle according to the present invention.

The control strategy according to the present invention is effected once power is supplied to the ECU and also during operation of the engine. In this embodiment, the engine is coupled to a vehicle drive-train by way of a CVT which has a predetermined engagement threshold speed at which engine output torque is transferred to the vehicle wheels. The vehicle may typically be a scooter or motorcycle of small capacity, but other vehicle applications are also envisaged as being within the scope of the present invention.

The engine further comprises a dual fluid fuel injection system for effecting the delivery of fuel entrained in air directly into the combustion chambers of the engine. Accordingly, a combustion event requires the scheduling of a fuel metering event, a fuel delivery event and an ignition event. The fuel delivery event may also be considered an air event as typically an air injector would be controlled to effect delivery of the metered quantity of fuel via air to the engine. The prevention of any one or more of these scheduled events will typically result in no subsequent combustion event within a corresponding cylinder of the engine. This in turn would result in a drop in engine speed or, if effected for all cylinders of the engine, the effective cessation of engine operation.

In essence, the purpose of the control strategy is to determine whether the engine is operating within either a crank or idle mode of operation, and if so, to ensure that the engine speed does not exceed the CVT engagement threshold speed as this may cause a vehicle runaway condition which may be hazardous to the rider.

Accordingly, at Steps 1 and 2 of the flow diagram, the engine operating mode or state is determined by the control system so as to assess the applicability of the control sub-strategy according to the present invention. The implementation of this sub-strategy is only performed when the engine state is in a crank or idle state, which is duly determined. If neither state is current, the sub-strategy is terminated and the ECU maintains normal operation of the engine. This may, for example, occur when the engine is operating at part or high load and the engine is coupled to the vehicle drive-train and is effecting vehicle motion in accordance with driver demand.

If however the ECU has determined that one of the two relevant states is current, the control system determines at Step 3, through the associated data acquisition system, the speed at which the engine is currently operating.

As part of the engine management control system, there is encoded ideal ranges within which the engine speed during the crank or idle states is expected to fall. The control system will thus react to an engine speed falling outside, and more particularly, exceeding these speed ranges. The present invention is targeted at those instances where, through mechanical or system failure, the control system is unable to exert sufficient control over the engine so as to bring the speed within the pre-determined limits. For example, such a scenario may arise where a fuel metering injector were to become stuck in the open position and as such result in an increased and uncontrolled supply of fuel to the engine.

Thus, at Step 3, the measured engine speed is compared with a threshold speed which is lower than the CVT engagement threshold speed. That is, a threshold speed may be set at a predetermined level slightly below the CVT engagement speed such that the ECU may be able to take action upon this lower threshold speed being exceeded and thus ensuring that the CVT engagement speed is never attained by the engine during the crank or idle states.

Alternatively, the measured engine speed may be compared with the CVT engagement threshold speed itself at Step 3. If the engine speed is below this engagement threshold speed, then the ECU is controlling the engine as expected and normal engine operation is maintained. If however the engine speed is determined as being greater than or equal to the engagement threshold speed, then the ECU must take action to ensure that the vehicle drive-train is not engaged during either the detected crank or idle mode of operation.

On reaching Step 4, the ECU disables the ignition, fuel and air events to prevent a subsequent combustion event from occurring in the or each cylinder of the engine. Typically, these events are disabled by the ECU simply not scheduling any of these events which would otherwise maintain engine operation. Hence, where fuel metering is effected by a separate fuel injector or fuel metering pump, no signal is provided to the device such that no fuel is metered into the air injector for subsequent delivery to the engine. Equally, the air injector is not opened and no ignition event is effected by the sparking means associated with the or each cylinder. This results in a drop in engine speed or more particularly cessation of engine operation thus ensuring that an engine speed runaway, and hence a vehicle runaway condition, is avoided.

As an alternative to disabling the engine by disabling each of these events, one or more of the fuel metering, air or ignition events may be disabled to reduce engine speed or provide for cessation of engine operation Step 3B. Further, other means of preventing a combustion event from occurring may also or alternatively be employed.

As alluded to hereinbefore, a slight variation to the control strategy as described above may in certain circumstances be applicable to certain engine applications. That is, following Step 3 and having determined that the threshold speed has been equaled or exceeded by the engine speed, the control system may initially endeavour to reduce the engine speed to a level below that of the threshold speed Step 3B, assuming this to be a first attempt (Step 3A). If following this attempt the engine speed simply increases once again to a level equal to or greater than the threshold speed, the control system may make yet a further attempt to reduce or control the engine speed down to a more desirable level. If the engine speed again proceeds to equal or exceed the threshold speed subsequent to this second speed reduction attempt by the control system, then the control strategy proceeds to Step 4 as previously described at which cessation of engine operation is typically effected. Hence, provided the engagement threshold speed of a CVT or similar device is not exceeded, the control system (as shown at Step 3A of the flow diagram) may be programmed to, for a predetermined number of times, attempt to control the engine speed down to a more desirable level prior to ceasing engine operation altogether. Such a variation to the control strategy would typically allow any once-off insignificant excursions of the engine speed above the threshold speed (i.e., where the threshold speed is set below the engagement speed of any speed related engagement device) to not result in instant shutdown or disabling of the engine.

Such a variation may be effected by the control system seeking to reduce engine speed to below the threshold speed by reducing the fuelling rate to the engine. Other means for reducing the engine speed may however also be used. In certain arrangements, the control system may seek to control the engine speed down to a predetermined idle speed rather than effect cessation of engine operation.

It is to be appreciated that, although a step or ramping function step has not been included in the flow diagram, such functions may be incorporated into the control system, as required.

Further, although the main embodiment has primarily been discussed with reference to speed dependent engagement devices, it is equally applicable as a means to prevent an engine speed runaway condition in general where such a condition may be detrimental to engine operation and durability. That is, regardless of the transmission unit associated with an engine, or in cases where an engine is “declutched” from the driving wheels of the vehicle, the invention is equally applicable as a means to prevent the attainment of unexpected or undesirable engine speeds during a crank or idle operating state. Still further, whilst the main embodiment discusses a direct injected fuel system, the invention also has applicability to port or manifold injected engines. The invention may also have applicability to other engine operating states or modes where the engine speed should not be able to exceed a predetermined threshold speed and result in a speed or vehicle runaway condition.

Unlike expensive mechanical means which may be used to prevent an engine speed and/or vehicle runaway condition, the present invention provides a simple and cheap means of enhancing rider safety.

Modifications and variations which would be deemed obvious to a skilled addressee are included within the scope of the present invention.

1. A method of controlling the speed of an engine operating in a crank or idle state, said engine connected to a vehicle drive-train through a speed related engagement device having a predetermined engagement speed or speed range at which the engine becomes coupled to the vehicle drive-train, including the steps of:
a) determining when the engine is operating in said crank or idle state;
b) determining whether the engine speed is above an upper threshold speed, and
c) controlling the engine when the engine speed is above the upper threshold speed so as to effect a reduction in the engine speed to avoid an engine speed runaway event.

2. The method according to claim 1, wherein the engine is disabled when the engine speed is above the upper threshold speed.

3. The method according to claims 1 or 2, wherein the threshold speed is an upper limit of a predetermined range of engine speeds within which the engine ideally runs during said crank or idle state.

4. The method according to any one of claims 1 to 3, wherein the engine is disabled by preventing one or a combination of scheduled events associated with the generation of a combustion event in at least one combustion chamber of the engine.

5. The method according to claim 4, wherein said scheduled events include a fuel metering event, a fuel delivery event and an ignition event.

6. The method according to claim 1, wherein the upper threshold speed is selected to be below the pre-determined speed or speed range.

7. The method according to any one of claims 1 to 6, wherein the speed related engagement device is a continuously variable transmission or a viscous coupling.

8. The method according to any one of claims 2 to 7, wherein at least one attempt is made to reduce the engine speed to below the upper threshold speed prior to the engine being disabled.

9. The method according to claim 8, wherein the engine speed is sought to be reduced by reducing the fuelling rate to the engine.

10. The method according to claims 8 or 9, wherein the engine speed is sought to be controlled down to a predetermined idle speed.

11. The method according to any one of the preceding claims, wherein the engine operates as a clean burn or stratified charge engine at some points of the engine operating load range.

12. The method according to any one of the preceding claims, wherein the engine includes a dual fluid fuel injection system arranged to deliver fuel directly into at least one combustion chamber of the engine.

13. The method according to any one of the preceding claims, wherein the vehicle is a scooter or a motorcycle.

14. An engine management control system for controlling the speed of an engine connected to a vehicle drive-train through a speed related engagement device having a predetermined engagement speed, or a speed range, at which the engine becomes coupled to the vehicle drive train, whilst the engine is operating in a crank or idle state, including state determination means to determine when the engine is operating in said crank or idle state, speed determination means to determine whether the engine speed is above an upper threshold speed for the engine whilst in said idle or crank state, and speed reduction means for reducing the engine speed wherein, when the engine speed is above the upper threshold speed the engine speed reduction means reduces the engine speed so as to avoid an engine speed runaway event.

15. The engine management control system of claim 14, wherein the engine speed reduction means is a means for disabling the engine such that when the engine speed is above the upper threshold speed the speed reduction means disables the engine so as to avoid an engine runaway event.

16. The engine management control system of claim 15, wherein the speed reduction means disables the engine by preventing one or a combination of scheduled events associated with the generation of a combustion event, in at least one combustion chamber of the engine.

17. The engine management control system of claim 16, wherein said scheduled events include a fuel metering event, a fuel delivery event, and an ignition event.

18. The engine management control system according to any one of claims 14 to 17, wherein the upper threshold speed is selected to be below the predetermined engagement speed or speed range.

19. The engine management control system according to any one of claims 14 to 18, wherein the speed related engagement device is a continuously variable transmission or a viscous coupling.

20. The engine management control system according to any one of claims 15 to 19, wherein the system makes at least one attempt to reduce the engine speed to below the upper threshold speed prior to the engine being disabled.

21. The engine management control system according to claim 20, wherein the engine speed is sought to be reduced by reducing the fuelling rate to the engine.

22. The engine management control system according to claims 20 or 21, wherein the engine speed is sought to be controlled down to a predetermined idle speed.

23. The engine management control system according to any one of claims 14 to 22, wherein the engine is operated as a clean burn or stratified charge engine at some points of the engine operating load range.

24. The engine management control system according to any one of claims 14 to 23 wherein the engine includes a dual fluid fuel injection system arranged to deliver fuel directly into at least one combustion chamber of the engine.

25. The engine management control system according to any one of claims 14 to 24, wherein the vehicle is a scooter or a motorcycle.
